(19) United States
(12) Patent Application Publication
(10) Pub. No.: US 2006/0160058 A1
(43) Pub. Date: Jul. 20, 2006

(54) I.Q. and aptitude testing and evaluation system

(75) Inventor: Chen Ming Chi, Taipei (TW)

Correspondence Address: LOWE HAUPTMAN BERNER, LLP, 1700 DIAGONAL ROAD, SUITE 300, ALEXANDRIA, VA, 22314, US

(73) Assignee: W.L. IQ - MEDIA FINGERPRINT INC.

(21) Appl. No.: 11/035,959

(22) Filed: Jan. 18, 2005

(51) Int. Cl. G09B 7/00

(52) U.S. Cl. 434/362

(57) ABSTRACT

An I.Q. and aptitude testing and evaluation system includes at least one reading apparatus at a user end, which is an electronic product enabling wireless communication, for retrieving a user's dermatoglyphic patterns or other traits of different parts of the body and converting the same into graphic signals for outputting; and an analyzing apparatus at an information provider end for receiving, classifying, and quantifying graphic signals output by the reading apparatus, searching for corresponding evaluation results from a databank thereof, and outputting the evaluation results to the reading apparatus for displaying at a display, allowing the user to obtain real-time evaluation information about an individual's I.Q. and aptitude.

### FIELD OF THE INVENTION

The present invention relates to a combination of computer software and hardware capable of testing and evaluating the I.Q. and aptitude of individuals in a simple and convenient manner. Using dermatoglyphic patterns, namely an individual's fingerprints, and/or other traits of different parts of the body, the system provides users with the ability to obtain real-time evaluation of an individual I.Q. and aptitude.

### BACKGROUND OF THE INVENTION

Since the scientific studies of fingerprints and the relationship of fingerprints to human behavior and metabolism were started by Italian scientist Marcello Malpighi (1626˜1794) in the fifteenth century, experts and scholars in the fields of medical science, education, and natural science have produced many studies and results concerning human body traits, such as personal dermatoglyphic patterns. For instance, Sir Francis Gaiton established the theory of the permanency and uniqueness of fingerprints in 1893; Elizabeth Wilson originated the employment of statistical methods in investigating the differences among the schizophrenic, the mentally deficient, and normal people in 1920; Harold Cummins, MD, the father of dermatoglyphics, established the science of dermatoglyphics in 1926 and set standards for discriminating dermatoglyphic patterns; Dr. Charlotte Wolff disclosed many statistical and analytical data about criminals' dermatoglyphic characteristics from 1940 to 1950; and Dr. Walker established dermatoglyphic indexes for determining Down's syndrome, with which 70% of people with Down's syndrome could be screened, establishing an important role in pediatrics. So far, worldwide there have been more than seven thousand articles concerning dermatoglyphics published in medical journals.

From long-term observations, records, comparisons, and generalizations by many scientists and medical experts, it has been established that the human congenital brain cell count (that is, human potential in learning) can be measured from a person's dermatoglyphic patterns on the hands and feet, as well as other personal traits from other body parts (such as irises). Further insight into and knowledge of the structure and functions of the human cerebral cortex can also be analyzed from personal body traits, including dermatoglyphic patterns. Since the specific weights of brain cells distributed in different cerebral cortex zones have influences on human learning abilities, it is possible to understand and determine differences in human I.Q. and aptitudes using scientific assessments, tests, and evaluations.

The inventor of the present invention has been developing and promoting for many years the study of the relationship between dermatoglyphic patterns and a person's genetic disposition, as well as the bearing it has on a human's psychological and mental development. The inventor has researched extensively and worked to associate the theory of plural intellects developed by Howard Gardner, a professor at Harvard University, for almost 20 years. The focus of such research correlates with the findings of many other experts in the fields of education, medicine and natural science on using medical genetic dermatoglyphs to test endowments so as to teach and educate people in different ways according to their unique personal temperament and potential.

As a result of constant improvements in the medical studies of genetic dermatoglyphic patterns, it is necessary to use a dynamic environment which is supported by constantly increasing numbers of test results to be able to accurately modify or amend study results. Therefore, it is inappropriate to simply rely on installing testing methods for an individual's I.Q. and aptitude in an independent stand-alone computer system.

In other words, it is preferable to store the testing methods in a remote databank for access in a uniform manner, so that a user may obtain real-time information about personal I.Q. and aptitude as a reference index for future learning.

Therefore, conveniently providing users with real-time, uniform, complete, and accurate personal I.Q. and aptitude comparison information without being limited by place and environment is an important issue.

### SUMMARY OF THE INVENTION

A primary object of the present invention is to provide a conveniently accessible I.Q. and aptitude testing and evaluation system for widespread use in the community. This enables a user or a person being tested to easily obtain real-time and accurate evaluation results. The results can be used as a reference index relating to aptitude for learning and training, and to support health care programs.

To achieve the above, the I.Q. and aptitude testing and evaluation system includes at least one (1) reading apparatus for the user and an analyzing apparatus. The reading apparatus is an electronic product enabling wireless telecommunication, such as a mobile phone, a personal digital assistant (PDA), or any other personal electronic product enabling wireless remote transmission, having at least one input, a wireless transmitting and receiving end, and a display. The analyzing apparatus includes an operating device and a databank. The reading apparatus is adapted to retrieve, via the input, a user's dermatoglyphic patterns or other traits of different parts of the body, and converts input into graphic signals which are received by the analyzing apparatus. The analyzing apparatus is adapted to classify and quantify the received graphic signals at the operating device, search for corresponding evaluation results from the databank, and generate the evaluation results to the reading apparatus. This enables the user to obtain real-time evaluation information about the individual's I.Q. and aptitude.

### BRIEF DESCRIPTION OF THE DRAWINGS

The structure and technical means adopted by the present invention to achieve the above and other related results can be best understood by referring to the following detailed description and the accompanying drawings. Specifically:

FIG. 1 is a schematic perspective view showing the system architecture of the present invention;

FIG. 2 is a block diagram of the present invention; and

FIG. 3 is a flowchart showing the operational aspect of the present invention.

### DETAILED DESCRIPTION OF THE PREFERRED EMBODIMENTS

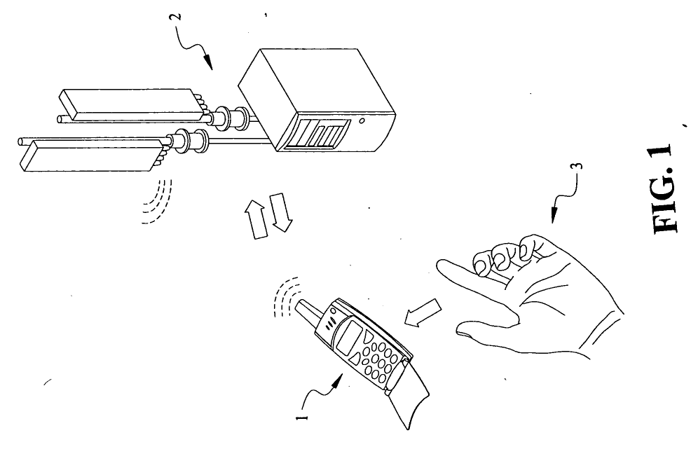

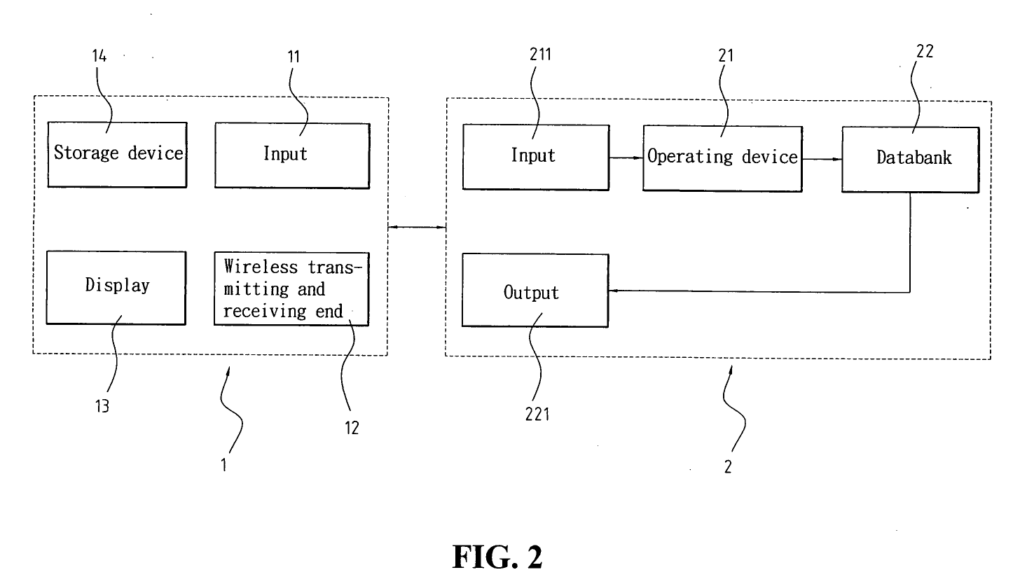

Please refer to FIGS. 1 and 2. The present invention relates to an I.Q. and aptitude testing and evaluation system, which includes a minimum of one reading apparatus 1 and an analyzing apparatus 2. The reading apparatus 1 and the analyzing apparatus 2 are linked by way of a wireless remote transmission for a user or a person being tested to obtain an evaluation result about the individual's I.Q. and aptitude, using the user's dermatoglyphic pattern or other traits of different parts of the body.

The reading apparatus 1 for the user is a portable electronic product for wireless telecommunication, such as a currently available mobile phone, personal digital assistant (PDA), or any other personal electronic apparatus for wireless remote transmission. The reading apparatus 1 provides the functions intended for general wireless telecommunication apparatus, and further includes an input 11, a wireless transmitting and receiving end 12, and a display 13.

The input 11 may be a CCD or a CMOS scanner fixedly mounted in the reading apparatus 1, or a CCD or a CMOS scanner adapted to the reading apparatus 1 for use. For example, the input 11 may have a plug for easily plugging into a mobile phone or a PDA for use. The input 11 is adapted to scan and receive a user's dermatoglyphic patterns, including fingerprints, palm prints, or footprints, that indicate personal traits, or the user's other traits of different parts of the body, such as the user's irises, and convert the received information into graphic signals for outputting to the analyzing apparatus 2. The analyzing apparatus 2 is adapted to search for characteristics of the received information about the user's dermatoglyphic patterns or other body traits, such as the density, depth, shape, and vesicle count of the user's dermatoglyph, and have these characteristics quantified.

The wireless transmitting and receiving end 12 is an electronic component adapted to operate remotely and transmit graphic signals (wireless), and receive and download signals from the analyzing apparatus 2. The wireless transmitting and receiving end 12 may be, for example, the transmitting end of a currently available mobile phone, PDA, etc., or a wireless remote transmitting component added to the reading apparatus 1.

The display 13 is adapted to display signals retrieved by the input 11 and signals received by the wireless transmitting and receiving end 12 from the analyzing apparatus 2, allowing the user to read messages, including pictures, data, or words, from the analyzing apparatus 2.

The I.Q. and aptitude testing and evaluation system of the present invention may further include a storage device 14 for recording graphic signals retrieved by the reading apparatus 1 and signals received by the wireless transmitting and receiving end 12 from the analyzing apparatus 2, so that the obtained and stored signals may be freely accessed by or transmitted to other apparatus, such as a personal computer.

The analyzing apparatus 2 at the information provider end is a wireless telecommunication apparatus, such as a local area wireless communication apparatus, a global communication apparatus, a satellite communication apparatus, or any other wireless communication apparatus enabling uploading and downloading of signals. The analyzing apparatus 2 includes an operating device 21 having at least one input 211 and a databank 22 having at least one output 221.

The databank 22 includes data about the distribution of human endowments (I.Q.) and human aptitudes, such as abilities relating to creation and thinking, spatial imagination, and rhythmic movement; perception of music and sentiments; the ability to recognize graphs; and the powers of organization and management, logical reasoning, language memory, reading, observation, and related skills. The databank 22 also includes data about the proportion and priority of these abilities and abilities in the brain, and the level of significance thereof.

The analyzing apparatus 2 receives via the input 211 of the operating device 21 the graphic signals output by the reading apparatus 1, and uses the operating device 21 to classify and quantify the received graphic signals, so as to search for corresponding evaluation results from the databank 22. The corresponding evaluation results are transmitted via the output 221 of the databank 22 to the wireless transmitting and receiving end 12 of the reading apparatus 1, and are displayed at the display 13 of the reading apparatus 1. The evaluation results include at least a picture showing locations in the brain where the different abilities or powers are distributed, and a TRC (Total Ridge Count) value that is a total measurement of the cerebral cortex, vesicles, and fine lines, representing the number of nerve cells. A higher TRC (Total Ridge Count) value represents higher I.Q. and stronger analytical capacity. The evaluation results also include at least one suggestive analysis, including work, skills, or trades suitable for the user in the future according to the user's congenital brain power; the user's congenital learning style, spirit, and type; the user's personality and characteristics developed from the endowments; the user's possible congenital physical condition; and recommendations about ways of improving the user's congenital diathesis.

With the I.Q. and aptitude testing and evaluation system configured from at least one reading apparatus 1 at the user end and an analyzing apparatus 2 at the information provider end, a user may carry the reading apparatus 1 along and retrieve personal dermatoglyphic patterns or traits of other parts of the body at any time and place without any limitation, and wirelessly communicate with the analyzing apparatus 2 at the information provider end to obtain messages about personal brain power, capacity, and aptitude as a reference index for future learning, training, and/or health care.

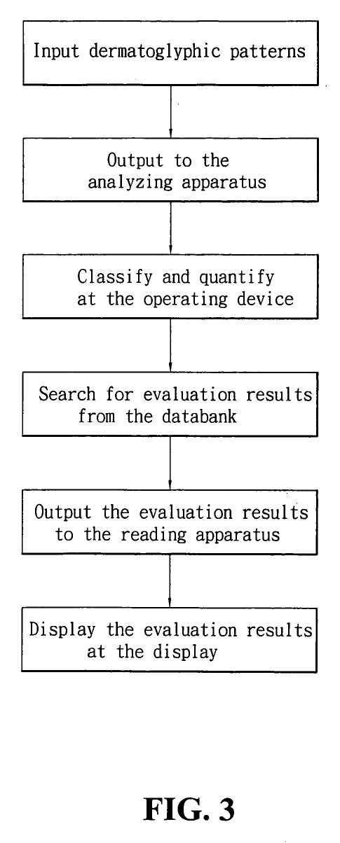

Refer to FIGS. 2 and 3. When a user 3 or an individual being tested desires to conduct a “self-test” of personal I.Q. and aptitude, the input 11 of the reading apparatus 1 is simply positioned at a selected part of the body to scan and retrieve personal dermatoglyphic patterns or other body traits, such as fingerprint, palm print, or footprint, of the selected body part. The retrieved personal dermatoglyphic patterns or other body traits are then automatically converted into graphic signals, which are output via the wireless transmitting and receiving end 12 of the reading apparatus 1 to the input 211 of the operating device 21 of the analyzing apparatus 2. The graphic signals received by the input 211 of the analyzing apparatus 2 are classified and quantified at the operating device 21 of the analyzing apparatus 2, enabling the databank 22 to search for corresponding evaluation results, which are output via the output 221 of the databank 22 to the wireless transmitting and receiving end 12 of the reading apparatus 1 and displayed at the display 13 on the reading apparatus 1. In this manner, the user 3 or individual being tested may easily and accurately obtain evaluations of his or her I.Q. and aptitude without being limited by time, place, or environment.

In the present invention, data about human body traits and characteristics are stored in the databank 22 of the analyzing apparatus 2 at the information provider end, and could be provided via wireless communication to multiple reading apparatuses 1 at the user end. The data stored in the databank 22 could be easily and conveniently updated with improvements in the medical field of genetic dermatoglyphics. Therefore, the I.Q. and aptitude testing evaluation system of the present invention provides multiple users using the reading apparatus 1 with real-time, uniform, complete, and accurate personal I.Q. and aptitude comparison information.

Moreover, data on users' handprints and related data are stored in the databank 22 of the analyzing apparatus 2 and may be protected against unauthorized access by using encryption equipment or encryption software. For example, in the case of encryption software, the encrypted handprint file, when being opened, will show only scrambled text to protect the user's personal data against unauthorized use.

The present invention has been described with a preferred embodiment thereof, and it is understood that many changes and modifications in the described embodiment can be carried out without departing from the scope and the spirit of the invention, which is intended to be limited only by the appended claims.

What is claimed is:

1. An I.Q. and aptitude testing and evaluation system, comprising:
at least one reading apparatus at a user end, which is a portable electronic product enabling wireless telecommunication, including at least one input, a wireless transmitting and receiving end, and a display; said input being a scanner either fixedly mounted in said reading apparatus or easily and removably plugged into said reading apparatus for retrieving a user's dermatoglyphic patterns or other personal traits of different parts of the body and converting the retrieved dermatoglyphic patterns or other personal body traits into graphic signals for outputting; and
an analyzing apparatus at an information provider end, which is a wireless telecommunication apparatus, including an operating device having at least one input and a databank having at least one output; said operating device being adapted to receive at same at least one input of said graphic signals output by said reading apparatus, and to classify and quantify said received graphic signals; said databank being adapted to search for and output evaluation results corresponding to said received graphic signals to said wireless transmitting and receiving end of said reading apparatus via said output of said databank.

2. The I.Q. and aptitude testing and evaluation system as claimed in claim 1, wherein said reading apparatus is selected from the group consisting of mobile phones and personal digital assistants (PDAs).

3. The I.Q. and aptitude testing and evaluation system as claimed in claim 1, wherein said input of said reading apparatus is selected from the group consisting of CCD scanners and CMOS scanners.

4. The I.Q. and aptitude testing and evaluation system as claimed in claim 1, wherein said wireless transmitting and receiving end of said reading apparatus is a component adapted to wirelessly and remotely transmit said graphic signals and to receive and download said evaluation result output by said analyzing apparatus, being selected from the group consisting of the transmitting ends of a mobile phone and PDA, and wireless remote transmitting components added to said reading apparatus.

5. The I.Q. and aptitude testing and evaluation system as claimed in claim 1, wherein said reading apparatus further includes a storage device for recording said graphic signals retrieved by said input of said reading apparatus, and said evaluation results received from said analyzing apparatus via said wireless transmitting and receiving end, and said graphic signals and said evaluation results stored in said storage device which are freely accessible by and transmissible to other apparatus.

6. The I.Q. and aptitude testing and evaluation system as claimed in claim 1, wherein said databank of said analyzing apparatus includes data about the distribution of human endowments (I.Q.) and of human aptitudes, such as abilities relating to creation and thinking, spatial imagination, and rhythmic movement; perception of music and sentiments; ability to recognize graphs; and the powers of organization and management, logical reasoning, language memory, reading, observation, etc.; said databank also including data about the proportions and priority of these abilities and powers in the brain, and/or the significant degree thereof.

7. The I.Q. and aptitude testing and evaluation system as claimed in claim 1, wherein said evaluation results include at least a picture showing locations in the brain where different abilities or powers are distributed, and a TRC (Total Ridge Count) value that is a total measurement of the cerebral cortex, vesicles, and fine lines.

8. The I.Q. and aptitude testing and evaluation system as claimed in claim 1, wherein said evaluation results include at least one suggestive analysis, including work, skills, or trades suitable for a user in the future according to the user's congenital brain power; the user's congenital learning style, spirit, and type; the user's personality and characteristics developed from the endowments; the user's possible congenital physical condition; and/or recommendations about the way to improve the user's congenital diathesis.

9. The I.Q. and aptitude testing and evaluation system as claimed in claim 1, wherein said databank of said analyzing apparatus is encrypted using encryption equipment or encryption software to protect data on users' handprints and related data stored in said databank against unauthorized access.

10. The I.Q. and aptitude testing and evaluation system as claimed in claim 9, wherein said encryption software for said databank enables said handprint files and related data to show only scrambled text when said files are opened.
